(19) United States
(12) Patent Application Publication
(10) Pub. No.: US 2025/0129494 A1
(43) Pub. Date: Apr. 24, 2025

(54) METAL POROUS BODY, NITROUS OXIDE DECOMPOSITION ELEMENT, AND NITROUS OXIDE DECOMPOSITION APPARATUS

(71) Applicants: Sumitomo Electric Industries, Ltd., Osaka (JP); National University Corporation Hokkaido University, Sapporo-shi (JP)

(72) Inventors: Yohei NODA, Osaka-shi (JP); Akihisa HOSOE, Osaka-shi (JP); Hiromasa TAWARAYAMA, Osaka-shi (JP); Kazuki OKUNO, Osaka-shi (JP); Kosei TAKEDA, Osaka-shi (JP); Takao MASUDA, Sapporo-shi (JP); Shin R. MUKAI, Sapporo-shi (JP); Yuta NAKASAKA, Sapporo-shi (JP); Nonoka RYUNO, Sapporo-shi (JP)

(73) Assignees: Sumitomo Electric Industries, Ltd., Osaka (JP); National University Corporation Hokkaido University, Sapporo-shi (JP)

(21) Appl. No.: 18/921,804

(22) Filed: Oct. 21, 2024

(30) Foreign Application Priority Data
Oct. 23, 2023 (JP) 2023-181761

(51) Int. Cl. C25B 11/031; C25B 11/046

(52) U.S. Cl. CPC C25B 11/031; C25B 11/046

(57) ABSTRACT

A metal porous body includes a framework having a three-dimensional mesh structure, wherein the framework includes a plurality of columnar supporting portions and a node portion that connects the plurality of columnar supporting portions, the framework is provided with a plurality of opening holes opened in a surface of the framework, and the framework contains at least one selected from a group consisting of nickel, cobalt, iron, tin, copper, and chromium.

### TECHNICAL FIELD

The present disclosure relates to a metal porous body, a nitrous oxide decomposition element, and a nitrous oxide decomposition apparatus. The present application claims priority based on Japanese Patent Application No. 2023-181761 filed on Oct. 23, 2023. The entire contents of the Japanese Patent Application are incorporated herein by reference.

### BACKGROUND

Japanese National Patent Publication No. 2003-512150 discloses a method of removing nitrogen oxide from a fluid by using a metal mesh structure as a base material and using a nitrogen oxide conversion catalyst disposed on the base material.

### SUMMARY

A metal porous body according to the present disclosure is a metal porous body including a framework having a three-dimensional mesh structure, wherein the framework includes a plurality of columnar supporting portions and a node portion that connects the plurality of columnar supporting portions, the framework is provided with a plurality of opening holes opened in a surface of the framework, and the framework contains at least one selected from a group consisting of nickel, cobalt, iron, tin, copper, and chromium.

### BRIEF DESCRIPTION OF THE DRAWINGS

FIG. 1 is an enlarged schematic view with attention being paid to one of cell portions in a framework having a three-dimensional mesh structure according to a first embodiment.

FIG. 2 is a schematic view showing one implementation of a shape of the cell portion.

FIG. 3 is a schematic view showing another implementation of the shape of the cell portion.

FIG. 4 is a schematic view showing another implementation of the shape of the cell portion.

FIG. 5 is a schematic view showing an implementation of two cell portions joined together.

FIG. 6 is a schematic view showing an implementation of four cell portions joined together.

FIG. 7 is a schematic view showing one implementation of the framework having the three-dimensional mesh structure formed by joining the plurality of cell portions.

FIG. 8 is a schematic view showing one implementation of the shape of the metal porous body according to the first embodiment.

FIG. 9 is a diagram showing an exemplary SEM image of a surface of the framework of the metal porous body according to the first embodiment.

FIG. 10 is a diagram showing an exemplary SEM image of a cross section of the framework of the metal porous body according to the first embodiment.

### DETAILED DESCRIPTION

### Problem to be Solved by the Present Disclosure

In Japanese National Patent Publication No. 2003-512150, the catalyst is applied onto the base material consisting of the metal mesh structure, thereby obtaining an ability of decomposing nitrous oxide. On the other hand, when the metal porous body consists of a catalyst substance, the metal porous body itself may have the ability of decomposing nitrous oxide. When the metal porous body itself is used as a nitrous oxide decomposition catalyst, it is effective to increase a specific surface area of the metal porous body in order to improve the ability of decomposing nitrous oxide.

Therefore, an object of the present disclosure is to provide a metal porous body having a large specific surface area, a nitrous oxide decomposition element consisting of the metal porous body, and a nitrous oxide decomposition apparatus including the nitrous oxide decomposition element.

### Advantageous Effect of the Present Disclosure

According to the present disclosure, it is possible to provide a metal porous body having a large specific surface area, a nitrous oxide decomposition element consisting of the metal porous body, and a nitrous oxide decomposition apparatus including the nitrous oxide decomposition element.

### Description of Embodiments

First, embodiments of the present disclosure will be listed and described.

(1) A metal porous body according to the present disclosure is a metal porous body including a framework having a three-dimensional mesh structure, wherein the framework includes a plurality of columnar supporting portions and a node portion that connects the plurality of columnar supporting portions, the framework is provided with a plurality of opening holes opened in a surface of the framework, and the framework contains at least one selected from a group consisting of nickel, cobalt, iron, tin, copper, and chromium.

According to the present disclosure, it is possible to provide a metal porous body having a large specific surface area.

(2) In (1), a BET surface area of the framework may be 0.8 m²/g or more. With this, the specific surface area of the metal porous body is further increased.

(3) In (1) or (2), an average of maximum diameters of the opening holes of the framework may be 0.1 μm or more and 2 μm or less. With this, the specific surface area of the metal porous body is further increased.

(4) In any of (1) to (3), in the surface of the framework, the number of the opening holes per unit area may be 1.6/μm² or more and 5/μm² or less. With this, the specific surface area of the metal porous body is further increased.

(5) In any of (1) to (4), a porosity of the framework may be 20% or more and 40% or less. With this, the specific surface area of the metal porous body is further increased. Further, strength of the framework is sufficient and handling thereof is readily performed.

(6) In any of (1) to (5), the metal porous body may contain potassium. With this, an ability of decomposing nitrous oxide in the metal porous body is improved.

(7) A nitrous oxide decomposition element according to the present disclosure is a nitrous oxide decomposition element consisting of the metal porous body according to any one of (1) to (6).

According to the present disclosure, a nitrous oxide decomposition element having an excellent ability of decomposing nitrous oxide can be provided.

(8) A nitrous oxide decomposition apparatus according to the present disclosure is a nitrous oxide decomposition apparatus including the nitrous oxide decomposition element according to (7).

According to the present disclosure, a nitrous oxide decomposition apparatus having an excellent ability of decomposing nitrous oxide can be provided.

[Details of Embodiments]

Specific examples of the metal porous body, the nitrous oxide decomposition element, and the nitrous oxide decomposition apparatus according to the present disclosure will be described below with reference to figures. The same reference characters indicate the same or corresponding portions in the figures of the present disclosure. Further, a dimensional relation such as a length, a width, a thickness, or a depth is modified as appropriate for clarity and brevity of the figures and does not necessarily represent an actual dimensional relation.

In the present specification, the expression “A to B” represents a range of lower to upper limits (i.e., A or more and B or less), and when no unit is indicated for A and a unit is indicated only for B, the unit of A is the same as the unit of B.

Moreover, when a compound or the like is expressed by a chemical formula in the present specification and an atomic ratio is not particularly limited, it is assumed that all the conventionally known atomic ratios are included, and the atomic ratio should not be necessarily limited only to one in the stoichiometric range.

In the present disclosure, when one or more numerical values are described as the lower limit and the upper limit of the numerical range, a combination of any one numerical value described as the lower limit and any one numerical value described as the upper limit is also disclosed.

In the present disclosure, the terms “comprise”, “include”, “have”, and variations thereof are open-ended terms. With each of the open-ended terms, an additional element may or may not be further included in addition to an essential element. The term “consisting of” is a closed term. It should be noted that even a configuration expressed by such a closed term can include an impurity involved in a normal case or an additional element irrelevant to the target technology. [First Embodiment: Metal Porous Body]

A metal porous body according to one embodiment (hereinafter, also referred to as “first embodiment”) of the present disclosure is a metal porous body including a framework having a three-dimensional mesh structure, wherein the framework includes a plurality of columnar supporting portions and a node portion that connects the plurality of columnar supporting portions, the framework is provided with a plurality of opening holes opened in a surface of the framework, and the framework contains at least one selected from a group consisting of nickel, cobalt, iron, tin, copper, and chromium.

### <Structure of Metal Porous Body>

In the first embodiment, the metal porous body includes the framework having the three-dimensional mesh structure. In the present disclosure, the three-dimensional mesh structure means a structure in which a solid component thereof is expanded three-dimensionally in the form of a mesh. Here, the solid component is a metal or the like.

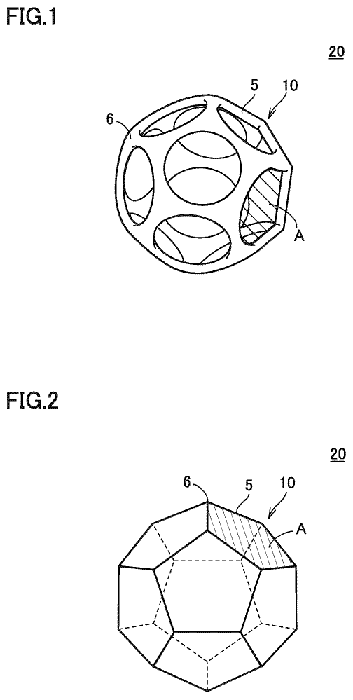

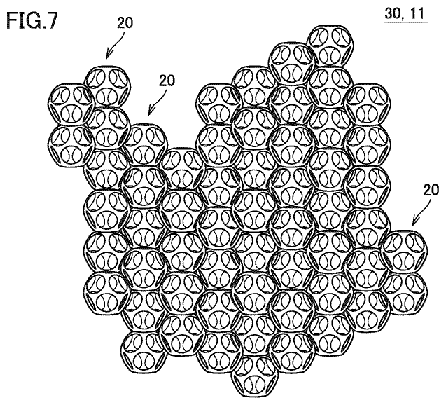

Hereinafter, in order to facilitate understanding of the three-dimensional mesh structure, a constituent unit of the three-dimensional mesh structure will be described as a cell portion 20. FIG. 1 is an enlarged schematic view of one cell portion included in the three-dimensional mesh structure according to the first embodiment. As shown in FIG. 7, a three-dimensional mesh structure 30 is formed by joining a plurality of the cell portions.

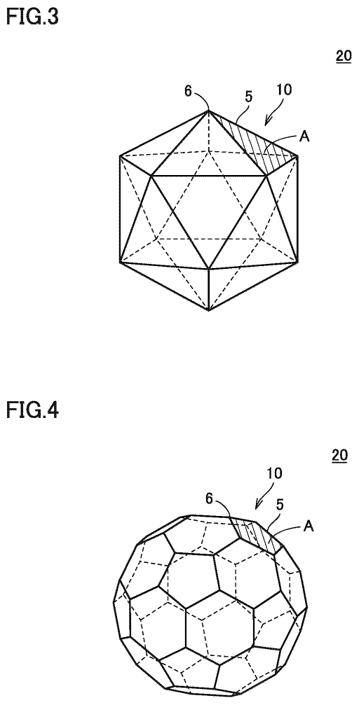

As shown in FIGS. 1 and 2, cell portion 20, which is a constituent unit of the three-dimensional mesh structure, includes a plurality of columnar supporting portions 5 and a node portion 6 that connects the plurality of columnar supporting portions 5. It can be expressed that the framework having the three-dimensional mesh structure is formed of the plurality of columnar supporting portions 5 and node portion 6 that connects the plurality of columnar supporting portions 5. Hereinafter, columnar supporting portions 5 and node portions 6 will be separately described, but there is no clear boundary therebetween and the plurality of columnar supporting portions 5 and the plurality of node portions 6 collectively form the framework having the three-dimensional mesh structure. In the description below, for ease of understanding, explanation will be made assuming that the shape of the cell portion in FIG. 1 is a regular dodecahedron shown in FIG. 2.

The plurality of columnar supporting portions 5 and the plurality of node portions 6 form a frame portion 10, which is a structure having a polygonal planar shape. Here, the polygonal planar shape means a polygonal shape when viewed in a plan view. In FIG. 2, the structure having a polygonal planar shape has a regular pentagonal shape, but the shape of the structure having a polygonal planar shape is not limited to the regular pentagonal shape. The structure having a polygonal planar shape may have another polygonal shape such as a triangular shape, a square shape, a hexagonal shape, or the like. Frame portion 10 forms a hole having a polygonal planar shape by the plurality of columnar supporting portions 5 and the plurality of node portions 6.

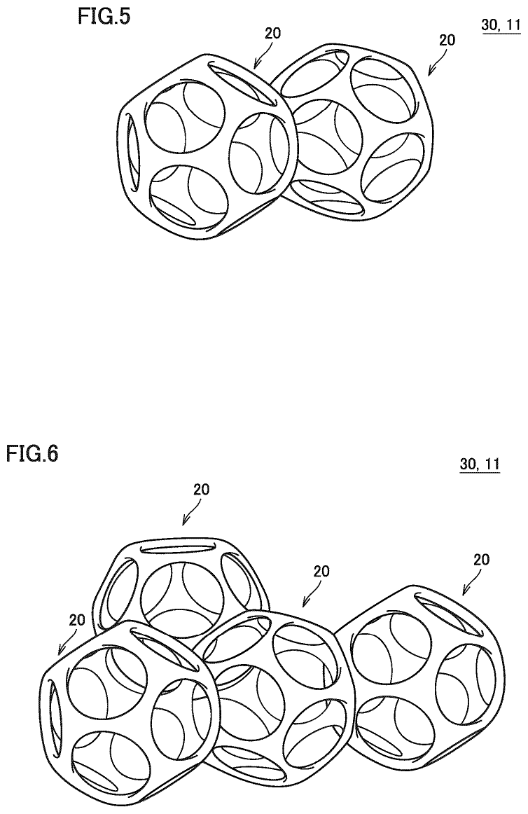

A plurality of frame portions 10 are combined to form cell portion 20, which is a three-dimensional polyhedron structure. Each of one columnar supporting portion 5 and one node portion 6 is shared by the plurality of frame portions 10. The shape of node portion 6 may be a sharp-edged shape having a vertex, may be a planar shape having a chamfered vertex, or may be a curved shape having a vertex with a curvature. In FIG. 2, the three-dimensional polyhedron structure has a dodecahedron shape, but may have another polyhedron shape such as a cubic shape, an icosahedron shape (FIG. 3), or a truncated icosahedron shape (FIG. 4). Cell portion 20 forms a three-dimensional space surrounded by an imaginary plane A defined by each of the plurality of frame portions 10.

As shown in FIGS. 5, 6, and 7, framework 11 having three-dimensional mesh structure 30 is formed by combining the plurality of cell portions 20. Frame portion 10 is shared by a plurality of cell portions 20. Frame portion 10 may be shared by two cell portions 20. It can also be expressed that framework 11 having three-dimensional mesh structure 30 consists of the plurality of frame portions 10. It can also be expressed that framework 11 having three-dimensional mesh structure 30 consists of the plurality of cell portions 20. Since the metal porous body according to the present disclosure includes framework 11 having three-dimensional mesh structure 30, the metal porous body can provided with communicating holes.

The metal porous body according to the present disclosure is provided with: a hole having a polygonal planar shape and formed by the frame portion; and a three-dimensional space formed by the cell portion. The metal porous body according to the present disclosure can be apparently distinguished from a two-dimensional mesh structure only provided with holes each having a planar shape, such as a punching metal or a baking rack. In the framework of the metal porous body according to the present disclosure, the plurality of columnar supporting portions and the plurality of node portions collectively form the three-dimensional mesh structure. Therefore, the three-dimensional mesh structure can be apparently distinguished from a structure such as a nonwoven fabric formed by entwining of fibers each serving as a constituent unit thereof.

The three-dimensional mesh structure according to the present disclosure is not limited to the above-described structure. For example, cell portion 20 may be formed by a plurality of frame portions 10 having different sizes and different planar shapes. The three-dimensional mesh structure may be formed by a plurality of cell portions 20 having different sizes and different three-dimensional shapes. The three-dimensional mesh structure may partially include a frame portion 10 provided with no hole having a polygonal planar shape, or may partially include a cell portion 20 that is provided with no three-dimensional space and that is solid inside.

A porosity (hereinafter, also referred to as “first porosity”) of the metal porous body may be 30% or more and 98% or less, may be 40% or more and 97% or less, or may be 50% or more and 96% or less. When the first porosity of the metal porous body is 30% or more, the metal porous body can be very light in weight and the surface area of the metal porous body can be large. When the first porosity of the metal porous body is 98% or less, the strength of the metal porous body can be sufficient.

In the present disclosure, the first porosity of the metal porous body is defined by the following formula:

First Porosity [%]=(Volume [cm³] of Pores of Metal Porous Body/Volume [cm³] of Metal Porous Body)×100

In the above-described formula, the volume of the metal porous body is a volume of the shape of an external appearance of the metal porous body.

A method of measuring each of the volume of the pores of the metal porous body and the volume of the metal porous body is as follows. Three-dimensional data of the metal porous body is acquired by X-ray CT, and each of the volume of the pores of the metal porous body and the volume of the metal porous body is found based on the three-dimensional data. The volume of a whole of a measurement region in the X-ray CT corresponds to the volume of the metal porous body in the above-described formula. A size of the measurement region in the X-ray CT is 2 mm³ or more. The size of the measurement region can be appropriately set in accordance with a size of a measurement target.

The volume of the pores of the obtained metal porous body and the volume of the metal porous body are substituted into the above-described formula, thereby calculating the first porosity of the metal porous body. Three measurement regions that do not overlap with one another are set for the metal porous body, which is one measurement target. In each of the three measurement regions, the volume of the pores of the metal porous body and the volume of the metal porous body are found and the porosity of the metal porous body is calculated. An average of the porosities of the metal porous body in the three measurement regions is calculated. In the present disclosure, the average of the porosities of the metal porous body in the three measurement regions corresponds to the first porosity of the metal porous body.

An average pore diameter (hereinafter, also referred to as “first average pore diameter”) of the metal porous body may be 250 μm or more and 3500 μm or less, may be 250 μm or more and 1000 μm or less, or may be 250 μm or more and 850 μm or less. The pore diameter of the metal porous body means the pore diameter of the three-dimensional space defined by the outer surface of the framework. When the first average pore diameter of the metal porous body is 250 μm or more, the strength of the metal porous body can be increased. When the first average pore diameter of the metal porous body is 3500 μm or less, bendability of the metal porous body can be increased. When the first average pore diameter of the metal porous body is 250 μm or more and 1000 μm or less, the ability of decomposing nitrous oxide is improved.

A method of measuring the first average pore diameter of the metal porous body is as follows. Three-dimensional data of the metal porous body is acquired by X-ray CT. A size of a measurement region in the X-ray CT is 2 mm³ or more. The size of the measurement region can be appropriately set in accordance with a size of a measurement target. Based on the three-dimensional data, all the pore diameters of the metal porous body in the measurement region are found. Here, the pore diameters of the metal porous body means equivalent volume diameters of the pores. When a part of a pore is located outside the measurement region, the pore is excluded from the measurement. An average (hereinafter, also referred to as “first-A average pore diameter”) of the pore diameters of all the pores in the measurement region is calculated.

The above-described measurement is performed in three measurement regions freely set in the metal porous body. The first-A average pore diameters are respectively calculated in the three measurement regions, and the first average pore diameter, which is the average of the first-A average pore diameters, is calculated. In the present disclosure, the first average pore diameter corresponds to the average pore diameter of the metal porous body.

It has been confirmed that as long as the measurement is performed in the same metal porous body, there is substantially no variation in the measurement result even when the measurement is performed a plurality of times with the positions of the three measurement regions being selected freely.

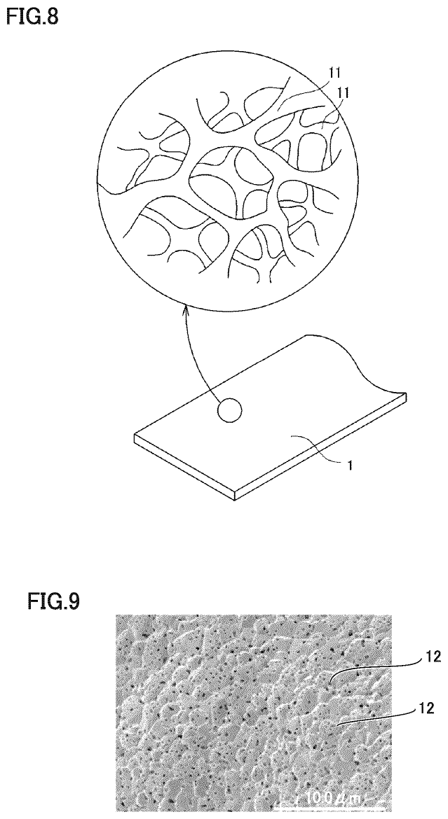

In the first embodiment, the shape of the metal porous body is not particularly limited, and can be appropriately selected depending on a purpose of use. For example, as shown in FIG. 8, the shape of metal porous body 1 may be a shape of sheet. Further, the shape of the metal porous body may be a shape of chip, a shape of block, or the like. Further, a plurality of metal porous bodies each having a shape of sheet may be stacked, or may be bent, rolled, compressed, or cut in accordance with a purpose of use.

An average thickness of the metal porous body is not particularly limited. The average thickness of the metal porous body may be 0.1 mm or more and 10 mm or less, may be 0.5 mm or more and 3 mm or less, may be 0.1 mm or more and 2.2 mm or less, or may be 0.1 mm or more and 1 mm or less.

The average thickness of the metal porous body is measured by a digital thickness gauge. The measurement of the thickness is performed at three locations freely set in a region located at a distance of 2 mm or more from the outer edge of the metal porous body. An average of the thicknesses at the three locations is calculated. In the present disclosure, the average of the thicknesses at the three locations corresponds to the average thickness of the metal porous body.

### <Opening Holes of Framework>

In the metal porous body according to the first embodiment, the framework is provided with the plurality of opening holes opened in the surface of the framework. Presence of the opening holes in the surface of the framework is confirmed by observing the surface of the framework using a scanning electron microscope (SEM). An observation magnification in the SEM can be 3,000 to 10,000 times.

FIG. 9 shows an exemplary SEM image of the surface of the framework of the metal porous body according to the first embodiment. As shown in FIG. 9, in the framework of the metal porous body according to the first embodiment, a plurality of opening holes 12 opened in the surface of the framework are present.

In the metal porous body according to the first embodiment, an average of maximum diameters of the opening holes of the framework may be 0.1 μm or more and 2 μm or less, may be 0.2 μm or more and 1.5 μm or less, or may be 0.3 μm or more and 1.0 μm or less. When the average of the maximum diameters of the opening holes is 0.1 μm or more, a fluid can readily flow into and out of the opening holes. When the average of the maximum diameters of the opening holes is 2 μm or less, the specific surface area of the metal porous body is increased.

A method of measuring the average of the maximum diameters of the opening holes of the framework is as follows. An SEM image of the surface of the framework of the metal porous body is acquired. An observation magnification in the SEM is 10,000 times. A measurement region having a rectangular shape of 5 μm×5 μm is set in the SEM image. The position of the measurement region in the SEM image can be freely set as long as the whole of the measurement region is set inside the framework portion. The maximum diameter of each of all the opening holes in the measurement region is measured. An opening hole having an outer edge entirely located in the measurement region is measured as a measurement target. When an opening hole is located at both inside and outside of the measurement region, the opening hole is not regarded as a measurement target.

The maximum diameter of the opening hole is the maximum effective diameter of the opening hole, and corresponds to the maximum value of a distance between two points on the outer edge of the opening hole. A method of measuring the maximum diameter of each of the opening holes is not particularly limited. For example, the SEM image may be printed and the maximum diameter of each of the opening holes may be measured using a scale, or the SEM image may be loaded into a personal computer and the maximum diameter of each of the opening holes is measured using Excel (trademark), Power Point (trademark), or image processing software.

An arithmetic average of the maximum diameters of all the opening holes in the measurement region is calculated.

The above-described measurement is performed in measurement regions respectively set in three SEM images acquired at regions that do not overlap with one another. For each of the three measurement regions, the arithmetic average (hereinafter, referred to as “first arithmetic average”) of the maximum diameters of all the opening holes in the measurement region is calculated. In the present disclosure, the average of the three first arithmetic averages corresponds to the average of the maximum diameters of the opening holes of the framework.

It has been confirmed that as long as the measurement is performed in the same metal porous body, there is substantially no variation in the measurement result even when the position of acquisition of the SEM image and the position of the measurement region in the SEM image are freely set.

In the metal porous body according to the first embodiment, the number of the opening holes per unit area in the surface of the framework may be 1.6/μm² or more and 5/μm² or less, may be 1.8/μm² or more and 4/μm² or less, or may be 2/μm² or more and 3/μm² or less. When the number of the opening holes per unit area is 1.6/μm² or more, the specific surface area of the metal porous body is further increased. When the number of the opening holes per unit area is 5/μm²or less, the strength of the framework is sufficient and handling of the metal porous body is readily performed.

A method of measuring the number of the opening holes per unit area in the surface of the framework is as follows. An SEM image of the surface of the framework of the metal porous body is acquired. An observation magnification in the SEM is 10,000 times. A measurement region having a rectangular shape of 5 μm×5 μm is set in the SEM image. The position of the measurement region in the SEM image can be freely set as long as the whole of the measurement region is set inside the framework portion. The number of all the opening holes in the measurement region is measured. An opening hole having an outer edge entirely located in the measurement region is measured as a measurement target. When an opening hole is located at both inside and outside of the measurement region, the opening hole is not regarded as a measurement target.

The method of measuring the number of the opening holes is not particularly limited. For example, the SEM image may be printed and the number of the opening holes may be counted with eyes, or the SEM image may be loaded into a personal computer and the number of the opening holes may be measured using image processing software.

The number of the opening holes per unit area is calculated based on the number of the opening holes in the measurement region and the area of the measurement region.

The above-described measurement is performed in measurement regions respectively set in three SEM images acquired at regions that do not overlap with one another. In each of the three measurement regions, the number of the opening holes per unit area is measured. In the present disclosure, an average of the numbers of the opening holes per unit area in the three measurement regions corresponds to the number of the opening holes per unit area in the surface of the framework.

It has been confirmed that as long as the measurement is performed in the same metal porous body, there is substantially no variation in the measurement result even when the position of acquisition of the SEM image and the position of the measurement region in the SEM image are freely set.

### <Composition of Framework>

In the metal porous body according to the first embodiment, the framework contains at least one selected from a group consisting of nickel, cobalt, iron, tin, copper, and chromium. The composition of the framework can be at least one selected from a group consisting of nickel, a nickel-chromium alloy, a nickel-cobalt alloy, a nickel-tin alloy, a nickel-iron alloy, a nickel-copper alloy, cobalt, a cobalt-chromium alloy, a cobalt-tin alloy, a cobalt-iron alloy, a cobalt-copper alloy, and copper.

A total content ratio of nickel, cobalt, iron, tin, copper, and chromium in the framework may be 80 mass % or more and 100 mass % or less, may be 83 mass % or more and 99 mass % or less, or may be 85 mass % or more and 98 mass % or less.

The framework can consist of at least one selected from the group consisting of nickel, cobalt, iron, tin, copper, and chromium. The framework can consist of: at least one selected from the group consisting of nickel, cobalt, iron, tin, copper, and chromium; and an impurity. Examples of the impurity include carbon, phosphorus, sulfur, oxygen, and chlorine. A content ratio of the impurity in the framework can be 20 mass % or less or 15 mass % or less.

The composition of the framework is specified in the following procedure. The metal porous body is embedded in a resin (for example, an epoxy resin), the resin is solidified, and then a surface thereof is processed using a polishing machine and a cross-section polisher, thereby exposing a cross section of the framework. The cross section of the framework is subjected to a surface analysis using an SEM-EDX, thereby specifying the composition thereof. A condition for the SEM-EDX is such that an acceleration voltage is 15 keV.

### <BET Surface Area of Framework>

In the metal porous body according to the first embodiment, a BET surface area of the framework may be 0.8 m²/g or more, may be 1.5 m²/g or more, or may be 5 m²/g or more from the viewpoint of increasing the specific surface area of the metal porous body. The upper limit of the BET surface area of the framework is not particularly limited, but may be 30 m²/g or less from the viewpoint of production. The BET surface area of the framework may be 0.8 m²/g or more and 30 m²/g or less, may be 1.5 m²/g or more and 25 m²/g or less, or may be 5 m²/g or more and 20 m²/g or less.

The BET surface area of the framework is measured using a specific surface area/pore distribution measurement apparatus (“BELSORP mini” (trademark) provided by MicrotracBEL Corp.). As pretreatment, the metal porous body is dried using a low-pressure dryer. A drying condition is 120° C. for 12 hours or more. An adsorption gas is nitrogen and an adsorption temperature is 77 K at the time of measurement.

### <Porosity of Framework>

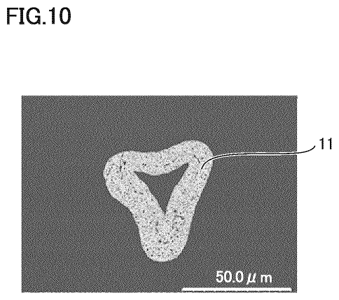

In the metal porous body according to the first embodiment, the framework can be provided with pores. FIG. 10 is a diagram showing an exemplary SEM image of the cross section of the framework of the metal porous body according to the first embodiment. As shown in FIG. 10, a plurality of small black regions are present in framework 11, and correspond to the pores present in the framework. It should be noted that a region surrounded by framework 11 is hollow; however, the hollow is not the pores of the framework.

In the metal porous body according to the first embodiment, the porosity of the framework may be 20% or more and 40% or less, may be 25% or more and 38% or less, or may be 30% or more and 35% or less. When the porosity of the framework is 20% or more, the specific surface area of the metal porous body is further increased. When the porosity of the framework is 40% or less, the strength of the framework is sufficient and handling thereof is readily performed.

A method of measuring the porosity of the framework is as follows. The metal porous body is embedded in a resin (for example, an epoxy resin), the resin is solidified, and then a surface thereof is processed using a polishing machine or a cross-section polisher, thereby exposing the cross section of the framework. An SEM image of the cross section of the framework is acquired. An observation magnification in the SEM is 5,000 times. A measurement region having a rectangular shape of 5 μm×5 μm is set inside the framework portion of the SEM image. The position of the measurement region in the SEM image can be freely set as long as the whole of the measurement region is set inside the framework portion. The SEM image is loaded into a personal computer and is subjected to binarization using image processing software. In the image after the binarization, the metal portion of the framework is shown in white, and the pores present in the framework are shown in black.

A percentage of the area of the pores with respect to the area of whole of the measurement region is calculated.

The above-described measurement is performed in measurement regions respectively set in three SEM images acquired at regions that do not overlap with one another. In each of the three measurement regions, the percentage of the area of the pores with respect to the area of the whole of the measurement region is calculated. In the present disclosure, the average of the percentages of the areas of the pores in the three measurement regions corresponds to the porosity of the framework.

It has been confirmed that as long as the measurement is performed in the same metal porous body, there is substantially no variation in the measurement result even when the position of acquisition of the SEM image and the position of the measurement region in the SEM image are freely set.

### <Potassium>

The metal porous body according to the first embodiment may contain potassium. In the metal porous body, a ratio (hereinafter, also referred to as “molar ratio of potassium”) of the number of moles of potassium to the total number of moles of nickel, cobalt, iron, tin, copper, and chromium may be 0.001 or more and 0.1 or less, may be 0.002 or more and 0.01 or less, or may be 0.003 or more and 0.008 or less from the viewpoint of improving the ability of decomposing nitrous oxide.

The molar ratio of potassium in the metal porous body is measured by an X-ray fluorescence (XRF) spectroscopy. Specifically, the molar ratio of potassium in the metal porous body is measured by applying X-rays onto the surface of the framework using an energy dispersive X-ray fluorescence spectrometer (“JSX-3100R II” (trademark) from JEOL).

### <Method of Producing Metal Porous Body>

A method of producing the metal porous body according to the first embodiment can include: a step of preparing a metal porous body precursor; an oxidation treatment step of performing oxidation treatment onto the metal porous body precursor; and a reduction treatment step of performing reduction treatment onto the metal porous body precursor having been through the oxidation treatment.

### <<Step of Preparing Metal Porous Body Precursor>>

A metal porous body precursor is prepared. As the metal porous body precursor, “Celmet (registered trademark)” provided by Sumitomo Electric Industries, Ltd., or the like can be used.

When the metal porous body precursor is not commercially available, the metal porous body precursor may be produced by the following method. A sheet of a resin molded body having a three-dimensional mesh structure is prepared. As the resin molded body, a polyurethane resin, a melamine resin, or the like can be used. Then, a conduction treatment step of forming a conductive layer on a surface of the resin molded body is performed. The conduction treatment can be performed, for example, by applying a conductive coating containing conductive particles such as carbon or conductive ceramic, by forming a layer of a conductive metal such as nickel or copper by an electroless plating method, or by forming a layer of a conductive metal by a vapor deposition method or a sputtering method. Then, a plating step of electroplating a metal such as nickel is performed using, as a base material, a resin molded body having a conductive layer formed on its surface. The electroplating may be performed in accordance with a known method.

Finally, by performing a removal step of removing, through heat treatment or the like, the resin molded body used as the base material, the metal porous body precursor including the framework having the three-dimensional mesh structure can be obtained.

### <<Oxidation Treatment Step>>

Next, the metal porous body precursor is subjected to oxidation treatment. The oxidation treatment is performed, for example, by heating the metal porous body precursor in a muffle furnace at 1000° C. to 1600° C. for 0.1 hour to 24 hours under an atmospheric air.

### <<Reduction Treatment Step>>

Next, the metal porous body having been through the oxidation treatment is subjected to reduction treatment. Thus, the metal porous body according to the first embodiment can be obtained.

The reduction treatment is performed, for example, in the following manner: the metal porous body precursor is kept in the muffle furnace and is heated at 400° C. to 800° C. for 0.1 hour to 10 hours under a H₂ (Ar balance) atmosphere of 4 volume % to 100 volume %.

The present inventors have found that by performing the oxidation treatment and the reduction treatment onto the metal porous body precursor, the plurality of opening holes opened in the outer surface can be formed in the surface of the framework.

### <<Potassium Carrying Step>>

The method of producing the metal porous body according to the first embodiment may include a potassium carrying step after the step of performing the reduction treatment. With this, a metal porous body containing potassium can be obtained.

The potassium carrying step can be performed in the following procedure. 5 mol/L of a KOH aqueous solution is prepared and the metal porous body is immersed therein. An ultrasonic wave of 120 kHz is applied thereto for 30 minutes, and then the metal porous body is left overnight at room temperature. Cleaning is performed about 5 times with distilled water. The liquid after the fifth or subsequent time of cleaning has a pH of 9 or more. After the cleaning, drying is performed. In this way, the metal porous body containing potassium can be obtained.

### <Purpose of Use of Metal Porous Body>

The metal porous body according to the first embodiment can be used not only for decomposition of nitrous oxide but also as an electrode of an alkaline water electrolysis apparatus or CO₂ electrolysis apparatus or as a base material for carrying a substance such as an amine or a catalyst.

### Second Embodiment: Nitrous Oxide Decomposition Element

A nitrous oxide decomposition element according to one embodiment (hereinafter, also referred to as “second embodiment”) of the present disclosure consists of the metal porous body according to the first embodiment. In the metal porous body according to the first embodiment, the specific surface area of the metal porous body is increased. Therefore, the nitrous oxide decomposition element consisting of the metal porous body can have an excellent ability of decomposing nitrous oxide.

In the second embodiment, the composition of the metal porous body may be nickel, cobalt, or a nickel-cobalt alloy. With this, the ability of decomposing nitrous oxide is further improved.

### Third Embodiment: Nitrous Oxide Decomposition Apparatus

A nitrous oxide decomposition apparatus according to one embodiment (hereinafter, also referred to as “third embodiment”) of the present disclosure includes the nitrous oxide decomposition element according to the second embodiment. The nitrous oxide decomposition element according to the second embodiment has the excellent ability of decomposing nitrous oxide. Therefore, the nitrous oxide decomposition apparatus according to the third embodiment can also have an excellent ability of decomposing nitrous oxide.

### EXAMPLES

The present embodiment will be described more specifically with reference to examples. It should be noted that the present embodiment is not limited by these examples.

### Production of Metal Porous Body

### <Samples 1 to 3>

### <<Step of Preparing Metal Porous Body Precursor>>

As the metal porous body precursor, “Nickel Celmet” (trademark) (product number: #8;average pore diameter: 0.45 mm; thickness: 1.2 mm; coating weight: 315 g/m²; porosity: 97%) provided by Sumitomo Electric Industries, Ltd., was prepared.

### <<Oxidation Treatment Step>>

Next, the metal porous body precursor was subjected to oxidation treatment. The oxidation treatment was performed by heating the metal porous body precursor in a muffle furnace at 1200° C. for 2 hours under an atmospheric air.

### <<Reduction Treatment Step>>

Next, the metal porous body having been through the oxidation treatment was subjected to reduction treatment. The reduction treatment was performed in the following manner: the metal porous body precursor was kept in the muffle furnace and was heated at 600° C. for 1 hour under a H₂ (Ar balance) atmosphere of 10 volume %. Thus, a metal porous body of sample 1 was obtained.

### <<Potassium Carrying Step>>

A potassium carrying step was further performed in the case of each of samples 2 and 3.5 mol/L of a KOH aqueous solution was prepared and the metal porous body was immersed therein. An ultrasonic wave of 120 kHz was applied thereto for 30 minutes and was then left overnight at room temperature. Sample 2 was cleaned six times with distilled water. Sample 3 was cleaned 5 times with distilled water. In each of samples 2 and 3, the liquid after the fifth or subsequent time of cleaning had a pH of 9 or more. After the cleaning, drying was performed. Thus, metal porous bodies of samples 2 and 3 were obtained.

### <Sample 4>

In a sample 4, the same metal porous body precursor as each of those in samples 1 to 3 was used as a metal porous body.

### <Sample 5>

In a sample 5, a metal porous body was obtained by performing the same potassium carrying step as that in sample 3 onto the same metal porous body precursor as each of those in samples 1 to 3. In sample 5, the oxidation treatment step and the reduction treatment step were not performed.

### Measurement of Metal Porous Body

The composition of the framework of the metal porous body of each sample was measured by an SEM-EDX. A specific measurement method is as described in the first embodiment. In each of all the samples, it was confirmed that the framework contained 85 mass % or more of nickel.

For the metal porous body of each sample, the SEM was used to measure presence or absence of opening holes in the surface of the framework, the porosity of the framework, the maximum diameters of the opening holes in the framework, and the number of the opening holes per unit area in the surface of the framework. Specific measurement methods are as described in the first embodiment. Results are shown in columns “Opening Holes in Surface”, “Porosity”, “Average of Maximum Diameters of Opening Holes”, and “Number of Opening Holes” of “Framework” in Table 1.

A BET surface area of the framework of the metal porous body of each sample was measured using a specific surface area/pore distribution measurement apparatus. A specific measurement method is as described in the first embodiment. Results are shown in the column “BET Surface Area” of “Framework” in Table 1.

In the metal porous body of each sample, respective content ratios of nickel and potassium in the metal porous body were measured by X-ray fluorescence spectroscopy. A ratio of the number of moles of potassium to the number of moles of nickel is shown in the column “K/Ni” of “Metal Porous Body” in Table 1. It should be noted that in each of all the samples, the framework does not contain cobalt, iron, tin, copper, and chromium. Therefore, the value of “K/Ni” in Table 1 corresponds to the ratio of the number of moles of potassium to the total number of moles of nickel, cobalt, iron, tin, copper, and chromium as described in the first embodiment.

TABLE 1

| | Framework | | | | | | | |
|---|---|---|---|---|---|---|---|---|
| | | | | Average | | | | |
| | | | | of | | | | |
| | | | | Maximum | | | | |
| | | | | Diameters | Number | | Metal | N₂O |
| | | | | of | of | BET | Porous | Decomposition |
| | | Opening Holes in | | Opening | Opening | Surface | Body | Ratio |
| Sample | | Surface | Porosity | Holes | Holes | Area | K/Ni | @450° C. |
| No. | Composition | Presence/Absence | % | μm | /μm² | m²/g | Molar Ratio | % |
| 1 | Ni | Present | 32.7 | 0.4 | 2.4 | 1.14 | — | 91.0 |
| 2 | Ni | Present | 30.8 | 0.4 | 2.5 | 1.14 | 0.001 | 96.9 |
| 3 | Ni | Present | 29.5 | 0.4 | 2.3 | 1.14 | 0.007 | 100.0 |
| 4 | Ni | Absent | 0 | — | 0 | 0.74 | — | 48.8 |
| 5 | Ni | Absent | 0 | — | 0 | 0.74 | 0.007 | 73.4 |

### Measurement of Nitrous Oxide Decomposition Ratio

In each of the samples, a nitrous oxide decomposition ratio was measured in the following procedure. The metal porous body of each sample was cut into a size of about 1 mm×1 mm, thereby preparing a test piece having a shape of chip.

A quartz tube was prepared as a flow path tube. An inner space of the quartz tube has a diameter of ¼ inch. A plurality of test pieces of 0.15 g in total each consisting of the metal porous body was introduced into the inner space of the flow path tube. In order to fix the metal porous body in the flow path tube, glass wool was disposed at both ends of the metal porous body. The quartz tube in which the test pieces each consisting of the metal porous body had been introduced was set in a tubular furnace and was heated at 600° C. for 1 hour.

As reaction gas, a mixed gas of nitrous oxide (N₂O) and argon (Ar) with a N₂O content ratio of 1 volume % was introduced at 10 cm³/min from one opening side of the flow path tube so as to measure the nitrous oxide decomposition ratio at 450° C.

The nitrous oxide decomposition ratio was calculated by using Q-mass connected online so as to measure the composition of the gas having passed through the metal porous body. Results of the nitrous oxide decomposition ratio at 450° C. are shown in the column “N₂O Decomposition Ratio” in Table 1. It is indicated that as the numerical value of the “N₂O decomposition ratio” is larger, the ability of decomposing nitrous oxide in the metal porous body is higher.

### Review

The metal porous bodies of samples 1 to 3 correspond to examples of the present disclosure. The metal porous bodies of samples 4 and 5 correspond to comparative examples. It was confirmed that each of the metal porous bodies of samples 1 to 3 had a larger specific surface area and a more excellent ability of decomposing nitrous oxide than those of each of the metal porous bodies of samples 4 and 5. Therefore, a nitrous oxide decomposition element consisting of each of the metal porous bodies of samples 1 to 3 also has an excellent ability of decomposing nitrous oxide, and a nitrous oxide decomposition apparatus including the nitrous oxide decomposition element can also have an excellent ability of decomposing nitrous oxide.

Heretofore, the embodiments and examples of the present disclosure have been illustrated, but it has been initially expected to appropriately combine the configurations of the embodiments and examples and modify them in various manners.

The embodiments and examples disclosed herein are illustrative and non-restrictive in any respect. The scope of the present invention is defined by the terms of the claims, rather than the embodiments and examples described above, and is intended to include any modifications within the scope and meaning equivalent to the terms of the claims.

What is claimed is:

1. A metal porous body comprising a framework having a three-dimensional mesh structure, wherein
the framework includes a plurality of columnar supporting portions and a node portion that connects the plurality of columnar supporting portions,
the framework is provided with a plurality of opening holes opened in a surface of the framework, and
the framework contains at least one selected from a group consisting of nickel, cobalt, iron, tin, copper, and chromium.

2. The metal porous body according to claim 1, wherein a BET surface area of the framework is 0.8 m²/g or more.

3. The metal porous body according to claim 1, wherein an average of maximum diameters of the opening holes of the framework is 0.1 μm or more and 2 μm or less.

4. The metal porous body according to claim 1, wherein in the surface of the framework, the number of the opening holes per unit area is 1.6/μm² or more and 5/μm² or less.

5. The metal porous body according to claim 1, wherein a porosity of the framework is 20% or more and 40% or less.

6. The metal porous body according to claim 1, wherein the metal porous body contains potassium.

7. A nitrous oxide decomposition element consisting of the metal porous body according to claim 1.

8. A nitrous oxide decomposition apparatus comprising the nitrous oxide decomposition element according to claim 7.
